(19) United States
(12) Patent Application Publication
(10) Pub. No.: US 2015/0314535 A1
(43) Pub. Date: Nov. 5, 2015

(54) A LINER AND METHOD OF MANUFACTURING THE SAME

(71) Applicant: GM GLOBAL TECHNOGY OPERATIONS LLC, Detroit, MI (US)

(72) Inventors: Bradley Tice, Clarkston, MI (US); David M. Connor, Grand Blanc, MI (US); Wayne R. Witkop, Macomb, MI (US)

(73) Assignee: GM GLOBAL TECHNOLOGY OPERATIONS LLC, Detroit, MI (US)

(21) Appl. No.: 14/798,981

(22) Filed: Jul. 14, 2015

Related U.S. Application Data
(62) Division of application No. 14/011,064, filed on Aug. 27, 2013.

(51) Int. Cl. B29C 70/02

(52) U.S. Cl. CPC B29C 70/021

(57) ABSTRACT

A method of manufacturing a liner, such as a wheelhouse liner, includes the following steps: (a) providing a textile blank; (b) dispensing a liquid-impermeable polymer only on a portion of the textile blank; (c) bonding the liquid-impermeable material to the textile blank; (d) changing a shape of the textile blank to form the liner; and (e) trimming the liner. The liner includes a substrate wholly or partly made of a textile. The substrate has a first surface and a second surface opposite the first surface. The liner further includes a liquid-impermeable coat bonded to the substrate. The liquid-impermeable coat partially covers the first surface of the substrate in order to minimize liquid flow through the substrate.

### CROSS-REFERENCE TO RELATED APPLICATION

The present application is a divisional of, and claims priority to, U.S. patent application Ser. No. 14/011,064, filed on Aug. 27, 2013, which is incorporated by reference herein in its entirety.

### TECHNICAL FIELD

The present disclosure relates to a liner, such as a wheelhouse liner, and a method of manufacturing the same.

### BACKGROUND

Most vehicles include wheelhouse liners. The wheelhouse liner may also be referred to as a wheel liner. The liners can be used for different purposes. For example, wheelhouse liners may be attached to the wheel well of a vehicle to attenuate noise. As used herein, the term “wheel well” means a portion of a vehicle body defining a cavity sized to receive portions of a wheel and a tire.

### SUMMARY

The present disclosure relates to a liner, such as a wheelhouse liner, and a method of manufacturing the same. Wheelhouse liners can serve as a barrier to protect certain parts of a vehicle from liquids.

The present disclosure relates to a method of manufacturing a liner such as a wheelhouse liner. In an embodiment, the method of manufacturing a liner includes the following steps: (a) providing a textile blank; (b) dispensing a liquid-impermeable material only on a portion of the textile blank; (c) bonding the liquid-impermeable material to the textile blank; (d) changing a shape of the textile blank to form the liner; and (e) trimming the liner.

The present disclosure also relates to a liner such as a wheelhouse liner. In an embodiment, the liner includes a substrate wholly or partly made of a textile. The substrate has a first surface and a second surface opposite the first surface. The liner further includes a liquid-impermeable coat bonded to the substrate. The liquid-impermeable coat partially covers the first surface of the substrate in order to minimize liquid flow through the substrate.

The present disclosure also relates to a vehicle. In an embodiment, the vehicle includes a vehicle body including a wheel well. The wheel well includes an inner surface defining a cavity. The vehicle further includes a wheel operatively coupled to the vehicle body. The wheel is sized to be received in the cavity defined by the inner surface of the wheel well. The vehicle further includes a wheelhouse liner coupled to the inner surface of the wheel well. The wheelhouse liner includes a substrate wholly or partly made of a textile. The substrate has a first surface and a second surface opposite the first surface. The first surface is coupled to the inner surface of the wheel well and faces the inner surface of the wheel well. The wheelhouse liner further includes a plurality of liquid-impermeable coats bonded to the first surface of the substrate. Each of the liquid-impermeable coats partially covers the first surface of the substrate in order to minimize liquid flow through the substrate.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic side view of a vehicle including a wheelhouse liner;

FIG. 2 is a schematic front view of a liner in accordance with an embodiment of the present disclosure;

FIG. 3 is a schematic side view of the liner of FIG. 2; and

FIG. 4 is a flowchart of a method of manufacturing a liner in accordance with an embodiment of the present disclosure.

### DETAILED DESCRIPTION

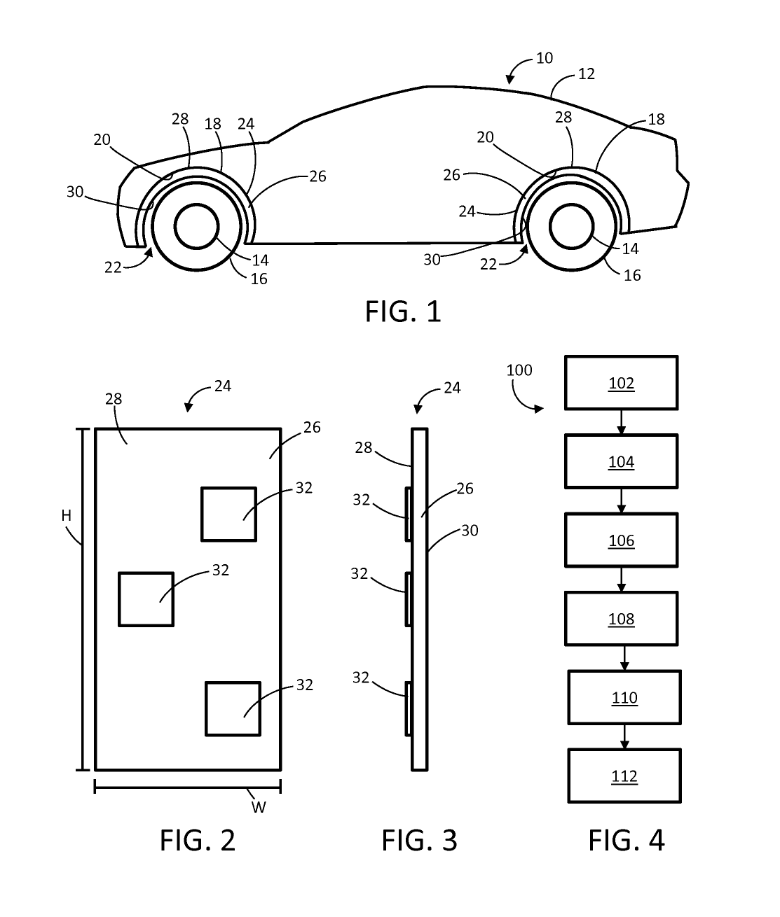

Referring now to the drawings, wherein the like numerals indicate corresponding parts throughout the several views, FIG. 1 illustrates a schematic of a vehicle 10. The vehicle 10 includes a vehicle body 12 and wheels 14 operatively coupled to the vehicle body 12. The vehicle 10 includes tires 16. Each tire 16 is operatively coupled to one wheel 14.

The vehicle body 12 includes wheel wells 18. The number of wheel wells 18 corresponds to the number of wheels 14. Each wheel well 18 includes an inner surface 20 substantially shaped as an arch. The inner surface 20 defines a cavity 22 configured, sized, and shaped to receive portions of one wheel 14 and one tire 16. Accordingly, the wheel well 18 surrounds at least a portion of one tire 16 and one wheel 14. Thus, one wheel 14 is sized to be partially received in the cavity 22 defined by the wheel well 18. Also, one tire 16 is sized to be partially received in the cavity 22 defined by the wheel well 18.

The vehicle 10 further includes a liner 24, such as a wheelhouse liner, coupled to some or all the wheel wells 18. The wheelhouse liner may also be referred to as a wheel liner. In the depicted embodiment, the liner 24 may be coupled to the wheel well 18 along the entire inner surface 20 via any suitable fasteners or adhesives. It is nevertheless contemplated that the liner 24 may be coupled to the wheel well 18 only along a portion of the inner surface 20.

With reference to FIGS. 2 and 3, the liner 24 includes a substrate 26. The substrate 26 may be wholly or partly made of a textile and, as such, may be referred to as a textile substrate. In the depicted embodiment, the substrate 26 includes a first surface 28 and a second surface 30 opposite the first surface. The first surface 28 may be referred to as a front surface, and the second surface 30 may be referred to as a rear surface. The first surface 28 can be coupled to the inner surface 20 of the wheel well 18 (FIG. 1). The second surface 30 faces the wheel 14 and the tire 16 partially surrounded by the wheel well 18 (FIG. 1). Thus, the liner 24 (e.g., wheel liner) may be coupled to the inner surface 20 of the wheel well 18.

With continued reference to FIGS. 2 and 3, the substrate 26 may be partly or wholly made of one or more polymers. As non-limiting examples, the substrate 26 may be wholly or partly made of a polymer such as polyester (e.g., polyethylene terephthalate (PET)), polypropylene (PP), and polyethylene (PE). The substrate 26 may also be wholly or partly made of blends, composites, or combination of polymers such polyester, polypropylene (PP), and polyethylene (PE). For instance, the substrate 26 may be wholly or partly made of a blend of polyester and polypropylene. Thus, the substrate 26 may include polymers or blends of polymers. It is envisioned that the substrate 26 may be wholly or partly made of any suitable sound-absorbing material such as polyester (e.g. polyethylene terephthalate (PET)), polypropylene (PP), and polyethylene (PE).

The liner 24 further includes at least one liquid-impermeable coat 32. The liquid-impermeable coat 32 is wholly or partly made of a liquid-impermeable material. As non-limiting examples, the liquid-impermeable coat 32 may be wholly or partly made of a polymer such as polyamide, polyolefin, polyurethane, and combinations thereof. For example, the liquid-impermeable coat 32 may be wholly or partly made of a polyolefin based material, a polyamide based material, or a polyurethane based material.

In the depicted embodiment, the liner 24 includes a plurality of liquid-impermeable coats 32 coupled to the first surface 28 of the substrate 26. It is envisioned, however, that the liner 24 may only include a single liquid-impermeable coat 32. None of the liquid-impermeable coats 32 cover the entire surface area of the first surface 28. Rather, each liquid-impermeable coat 32 only partially covers the first surface 28 of the substrate 26 in order to minimize liquid flow through the substrate 26. It is useful to place the liquid-impermeable coats 32 in specific areas of the substrate 26 in order to minimize costs and minimize the effect of the liquid-impermeable coats 32 in the acoustic performance of the substrate 26. For instance, at least one of the liquid-impermeable coats 32 does not extend along the entire height H of the first surface 28 of the substrate 26. Furthermore, at least one of the liquid-impermeable coats 32 does not extend along the entire width W of the first surface 28 of the substrate 26. It is envisioned, however, that at least one liquid-impermeable coat 32 may cover the entire surface area of the first surface 28 of the substrate 26. Although FIGS. 2 and 3 show that the liner 24 has a substantially planar shape, it is contemplated that the liner 24 may have a curved shape in order to properly fit in the wheel well 18. As discussed below in detail, reference number 26 may alternatively represent a blank that can be trimmed to form the substrate 26 of the liner 24. The blank may therefore include the first surface 28 and the second surface 30.

With reference to FIG. 4, the method 100 of manufacturing the liner 24 (e.g., wheelhouse liner). In the depicted embodiment, the method 100 begins at step 102. Step 102 entails providing a blank wholly or partly made of a textile (e.g., a textile blank). Thus, step 102 may include providing a textile blank. This blank may be wholly or partly made of a polymer such as polyester, polypropylene (PP), polyethylene (PE), or a combination thereof. For instance, the textile blank may be entirely or partly made of a blend of polyester and polypropylene. As discussed below, the substrate 26 is made out of the textile blank and therefore includes a first surface 28 and a second surface 30 opposite to the first surface 28. The first surface 28 of the liner substrate 26 (FIG. 3) corresponds to a portion of the first surface of the blank, while the second surface 30 of the substrate 26 (FIG. 3) corresponds to a portion of the second surface of the blank. The blank may be provided by using rollers and a conveyor belt. After providing the blank, the method 100 continues to step 104.

Step 104 entails dispensing a liquid-impermeable material, such as a liquid-impermeable polymer, on the first surface 28 of the blank. For instance, step 102 may include dispensing a liquid-impermeable material, such as a liquid-impermeable polymer, on a portion of the first surface 28 of the blank such that the liquid-impermeable material portion does not cover the entire surface area of the first surface 28 of the blank. The liquid-impermeable material may be wholly or partly made of a polyolefin based material and may be dispensed only on specific areas of the blank. These specific areas of the blank may be determined in advance by the manufacturer. For example, the liquid-impermeable material may be disposed on areas of the blank that would necessitate liquid impermeability in order to protect electronic components or an air induction system of the vehicle 10. It is contemplated that the liquid-impermeable material may be dispensed only in a single area of the first surface 28 of the blank. Thus, step 104 may entail dispensing a liquid-impermeable material only on a portion of a textile blank. Specifically, step 104 may include dispensing the liquid-impermeable material only on the first surface 28 of the textile blank. Alternatively, the liquid-impermeable material may be dispensed in different discrete and separate areas of the first surface 28 of the blank. In any event, the liquid-impermeable material does not have to cover the entire surface area of the front surface of the blank. Step 104 may therefore include dispensing the liquid-impermeable material only on a portion of the first surface 28 of the blank (e.g., textile blank) such that the liquid-impermeable material does not cover the entire surface area of the first surface 28 of the blank. At step 104, the liquid-impermeable material may be in liquid form and may be sprayed on the blank using a robot. Step 104 may therefore include spraying the liquid-impermeable material on the first surface 28 of the blank (e.g., textile blank). As non-limiting examples, the liquid-impermeable material may be a liquid-impermeable polymer such as polyamide, polyolefin, polyurethane, or combinations thereof. Thereafter, the method 100 continues to step 106.

Step 106 entails coupling the liquid-impermeable material to the blank. For instance, step 106 may entail bonding a liquid-impermeable polymer to the blank. To do so, the blank and the liquid-impermeable material may be heated using, for example, an oven or any suitable apparatus capable of generating heat. As the blank and the liquid-impermeable material are heated, the liquid-impermeable material melts or at least softens. Thus, step 106 may include heating the liquid-impermeable material (e.g., liquid-impermeable polymer). Next, the liquid-impermeable material is cured. To do so, the blank and the liquid-impermeable material may be allowed to cool off for a predetermined amount of time. The liquid-impermeable material may be cured in a mold. Accordingly, step 106 includes curing the liquid-impermeable material (e.g., liquid-impermeable polymer). Next, the method 100 continues to step 108.

Step 108 entails forming the blank (e.g., textile blank). In other words, step 108 may include changing the shape of at least the blank (e.g., textile blank) to a desired shape in order to form the liner 24 (e.g., wheelhouse liner). For instance, the blank may initially be substantially planar. At step 108, the shape of the blank is changed from a substantially planar shape to substantially curved shape. Thus, step 108 may entail changing the shape of the textile blank. To do so, the blank and the liquid-impermeable material bonded to the blank may be molded. Step 108 may therefore include molding the blank (e.g., textile blank). However, it is envisioned that other forming processes may be employed to change the shape of the blank and the liquid-impermeable material bonded to the blank. Next, the method 100 continues to step 110.

Step 110 entails trimming the liner 24 (e.g., wheelhouse liner). Therefore, step 110 may entail trimming the liner 24. As non-limiting examples, the liner may be trimmed using a water jet or a trim die. Regardless of the trimming method employed, the liner 24 is trimmed in order to adjust its shape and size.

If the method 100 is a method of manufacturing the liner 24 (e.g., wheelhouse liner), then the method 100 ends at step 110. However, the method 100 may represent a method of manufacturing the vehicle 10. In such a case, the method 100 includes at least one additional step (i.e., step 112). After trimming the blank to form the liner 24, the method 100 continues to step 112. Step 112 entails coupling the liner 24 to at least one of the wheel wells 18 of the vehicle 10. Specifically, the liner 24 may be coupled to the wheel well 18 such that the first surface 28 faces the inner surface 30 of the wheel well 18 and the second surface 30 faces the wheel 14. Fasteners or adhesives may be used to couple the liner 24 to the wheel well 18. Alternatively, the first surface 28 may face away from the inner surface 30 of the wheel well 18.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method, comprising:
providing a textile blank, wherein the textile blank includes a first surface and a second surface opposite to the first surface;
dispensing a liquid-impermeable material only on the first surface of the textile blank;
bonding the liquid-impermeable material to the textile blank;
changing a shape of the textile blank to form a liner;
trimming the liner;
coupling the liner to a wheel well of a vehicle such that the first surface faces an inner surface of the wheel well and the second surface faces away from the wheel well; and
wherein the wheel well defines a cavity sized to partially receive a wheel of the vehicle.

2. The method of claim 1, wherein the wheel well has an inner surface, an entirety of the inner surface defines the cavity, and coupling the liner to the wheel well includes coupling the liner to the entirety of the inner surface of the wheel well.

3. The method of claim 1, wherein the textile blank is made of a blend of polyester and polypropylene, and the liquid-impermeable material is a polyolefin based material.

4. The method of claim 1, wherein the first surface has a height and a width, and the liquid-impermeable material does not extend along an entirety of the height of the first surface.

5. The method of claim 4, wherein the liquid-impermeable material does not extend along an entirety of the width of the first surface.

6. The method of claim 1, wherein the textile blank comprises a polymer selected from a group consisting of polyester, polypropylene, polyethylene, and a combination thereof.

7. The method of claim 1, wherein bonding the liquid-impermeable material to the textile blank includes heating the liquid-impermeable material.

8. The method of claim 1, wherein bonding the liquid-impermeable material to the textile blank includes curing the liquid-impermeable material.

9. The method of claim 1, wherein changing the shape of the textile blank includes molding the textile blank.

10. The method of claim 1, wherein changing the shape of the textile blank includes changing the shape of the textile blank from a planar shape to a curved shape.

11. The method of claim 1, wherein dispensing the liquid-impermeable material includes dispensing the liquid-impermeable material only on a portion of the first surface of the textile blank such that the liquid-impermeable material does not cover an entire surface area of the first surface of the textile blank.

12. The method of claim 1, wherein dispensing the liquid-impermeable material includes dispensing the liquid-impermeable material only on a portion of the first surface of the textile blank such that the liquid-impermeable material does not cover an entire surface area of the first surface of the textile blank.

13. The method of claim 1, wherein dispensing the liquid-impermeable material includes dispending the liquid-impermeable material in different areas of the first surface of the textile blank.

14. A method, comprising:
providing a textile blank, wherein the textile blank includes a first surface and a second surface opposite to the first surface;
dispensing a liquid-impermeable material only on the first surface of the textile blank;
bonding the liquid-impermeable material to the textile blank;
changing a shape of the textile blank to form a liner;
coupling the liner to a wheel well of a vehicle such that the first surface faces an inner surface of the wheel well and the second surface faces away from the wheel well; and
wherein the wheel well defines a cavity sized to partially receive a wheel of the vehicle.

15. The method of claim 14, wherein the wheel well has an inner surface, an entirety of the inner surface defines the cavity, and coupling the liner to the wheel well includes coupling the liner to the entirety of the inner surface of the wheel well.

16. The method of claim 14, wherein the textile blank is made of a blend of polyester and polypropylene, and the liquid-impermeable material is a polyolefin based material.

17. The method of claim 14, wherein the first surface has a height and a width, and the liquid-impermeable material does not extend along an entirety of the height of the first surface.

18. The method of claim 17, wherein the liquid-impermeable material does not extend along an entirety of the width of the first surface.

19. The method of claim 14, further comprising trimming the liner.

20. The method of claim 19, wherein the liner is trimmed after changing the shape of the textile blank.
